(19) United States
(12) Patent Application Publication
(10) Pub. No.: US 2014/0133433 A1
(43) Pub. Date: May 15, 2014

(54) COMMUNICATION METHOD AND WIRELESS DEVICE SUPPORTING VARIABLE BANDWIDTH

(71) Applicants: Joon Kui Ahn, Anyang-si (KR); Dong Youn Seo, Anyang-si (KR); Hak Seong Kim, Anyang-si (KR); Suck Chel Yang, Anyang-si (KR)

(72) Inventors: Joon Kui Ahn, Anyang-si (KR); Dong Youn Seo, Anyang-si (KR); Hak Seong Kim, Anyang-si (KR); Suck Chel Yang, Anyang-si (KR)

(73) Assignee: LG ELECTRONICS INC., Seoul (KR)

(21) Appl. No.: 14/130,638

(22) PCT Filed: Jul. 13, 2012
(86) PCT No.: PCT/KR2012/005578

§ 371 Date: Jan. 2, 2014

Related U.S. Application Data
(60) Provisional application No. 61/508,071, filed on Jul. 15, 2011.
(60) Provisional application No. 61/554,960, filed on Nov. 2, 2011.

(51) Int. Cl. H04W 72/04; H04W 74/08

(52) U.S. Cl. CPC H04W 72/04; H04W 74/0833
USPC 370/329

(57) ABSTRACT

A wireless device transmits to a base station, which supports a basic bandwidth, a random preamble for indicating an operating bandwidth, and the wireless device receives a random access response from the base station as a response to the random access preamble. The operating bandwidth is smaller than the basic bandwidth.

### BACKGROUND OF THE INVENTION

1. Field of the Invention

The present invention relates to wireless communications, and more particularly, to a communication method for supporting a variable bandwidth in a wireless communication system, and a wireless device using the method.

2. Related Art

Long term evolution (LTE) based on 3rd generation partnership project (3GPP) technical specification (TS) release 8 is a promising next-generation mobile communication standard. Recently, LTA-A (LTE-advanced) based on 3GPP TS release 10 supporting multiple carriers is under standardization.

In a next-generation wireless communication system, it is considered to provide a service for a low cost/low specification device which primarily aims at data communication, such as reading a meter, measuring a water level, utilizing a camera, inventory reporting of a vending machine, etc.

For example, machine-type communication (MTC) is one type of data communication including one or more entities not requiring human interactions, and is also called machine to machine (M2M) communication. That is, the MTC refers to the concept of communication based on the legacy wireless communication network used by a mechanical device instead of a user equipment (UE) used by a user. The mechanical device used in the MTC is called an MTC device or an M2M device.

An MTC service requires a low transmission data amount, and not frequently transmits and receives data. Therefore, it is effective to decrease a unit cost of a device and to decrease a battery consumption according to a low data transmission rate. For example, if an operating bandwidth of an MTC device is smaller than that of the legacy mobile terminal, a radio frequency (RF)/baseband complexity of the MTC device can be significantly decreased.

Although the legacy LTE/LTE-A system also supports various bandwidths such as 20 MHz, 10 MHz, 5 MHz, etc., it cannot support wireless devices supporting a plurality of bandwidths. One base station or network system supports only one bandwidth. For example, if the base station supports a 20 MHz bandwidth, only a wireless device supporting the 20 MHz bandwidth can access the base station.

However, wireless devices supporting a narrowband such as the MTC device may be deployed within a coverage of the base station. According to the legacy mobile communication system, a device having a 5 MHz bandwidth cannot access a base station having a 20 MHz bandwidth.

### SUMMARY OF THE INVENTION

The present invention provides a communication method supporting various bandwidths and a wireless device using the method.

According to one aspect of the present invention, a communication method supporting a variable bandwidth in a wireless communication system is provided. The method includes: transmitting by a wireless device a random access preamble indicating an operating bandwidth to a base station supporting a reference bandwidth; and receiving by the wireless device a random access response from the base station in response to the random access preamble, wherein the operating bandwidth is smaller than the reference bandwidth.

In the aforementioned aspect of the present invention, a plurality of candidate random access preambles may be divided into a first group and a second group, and the first group may indicate the reference bandwidth and the second group indicates the operating bandwidth. The random access preamble may be randomly selected from candidate random access preambles included in the second group.

In addition, the operating bandwidth may be indicated according to a resource for transmitting the random access preamble.

According to another aspect of the present invention, a wireless device supporting a variable bandwidth in a wireless communication system is provided. The wireless device includes: a radio frequency (RF) unit for transmitting and receiving a radio signal; and a processor operatively coupled to the RF unit, wherein the processor is configured for: transmitting a random access preamble indicating an operating bandwidth to a base station supporting a reference bandwidth; and receiving a random access response from the base station in response to the random access preamble, wherein the operating bandwidth is smaller than the reference bandwidth.

A base station can provide a service to wireless devices having various bandwidths.

### BRIEF DESCRIPTION OF THE DRAWINGS

FIG. 1 shows a structure of a downlink radio frame in 3rd generation partnership project (3GPP) long term evolution-advanced (LTE-A).

FIG. 2 shows a structure of an uplink subframe in 3GPP LTE-A.

FIG. 3 shows an example of monitoring a physical downlink control channel (PDCCH).

FIG. 4 shows an example of displaying a reference signal and a control channel in a downlink subframe.

FIG. 5 shows an example of a subframe having an extended PDCCH.

FIG. 6 is a flowchart showing the conventional random access procedure.

FIG. 7 shows a random access procedure according to an embodiment of the present invention.

FIG. 8 shows scheduling using an extended-PDCCH (ePDCCH).

FIG. 9 shows an example of physical uplink control channel (PUCCH) resource allocation at an operating bandwidth.

FIG. 10 is a block diagram of a wireless communication system according to an embodiment of the present invention.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a wireless device, a personal digital assistant (PDA), a wireless modem, a handheld device, a terminal, a wireless terminal, etc. The wireless device may also be a device supporting only data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

Hereinafter, it is described that the present invention is applied according to a 3rd generation partnership project (3GPP) long term evolution (LTE) based on 3GPP technical specification (TS) release 9 or 3GPP LTE-A based on 3GPP TS release 10. However, this is for exemplary purposes only, and thus the present invention is also applicable to various wireless communication networks.

A wireless device may be served by a plurality of serving cells. Each serving cell may be defined with a downlink (DL) component carrier (CC) or a pair of a DL CC and an uplink (UL) CC.

The serving cell may be classified into a primary cell and a secondary cell. The primary cell operates at a primary frequency, and is a cell designated as the primary cell when the UE performs an initial network entry process or starts a network re-entry process or performs a handover process. The primary cell is also called a reference cell. The secondary cell operates at a secondary frequency. The secondary cell may be configured after an RRC connection is established, and may be used to provide an additional radio resource. At least one primary cell is configured always. The secondary cell may be added/modified/released by using higher-layer signaling (e.g., RRC messages).

A cell index (CI) of the primary cell may be fixed. For example, a lowest CI may be designated as a CI of the primary cell. It is assumed hereinafter that the CI of the primary cell is 0 and a CI of the secondary cell is allocated sequentially starting from 1.

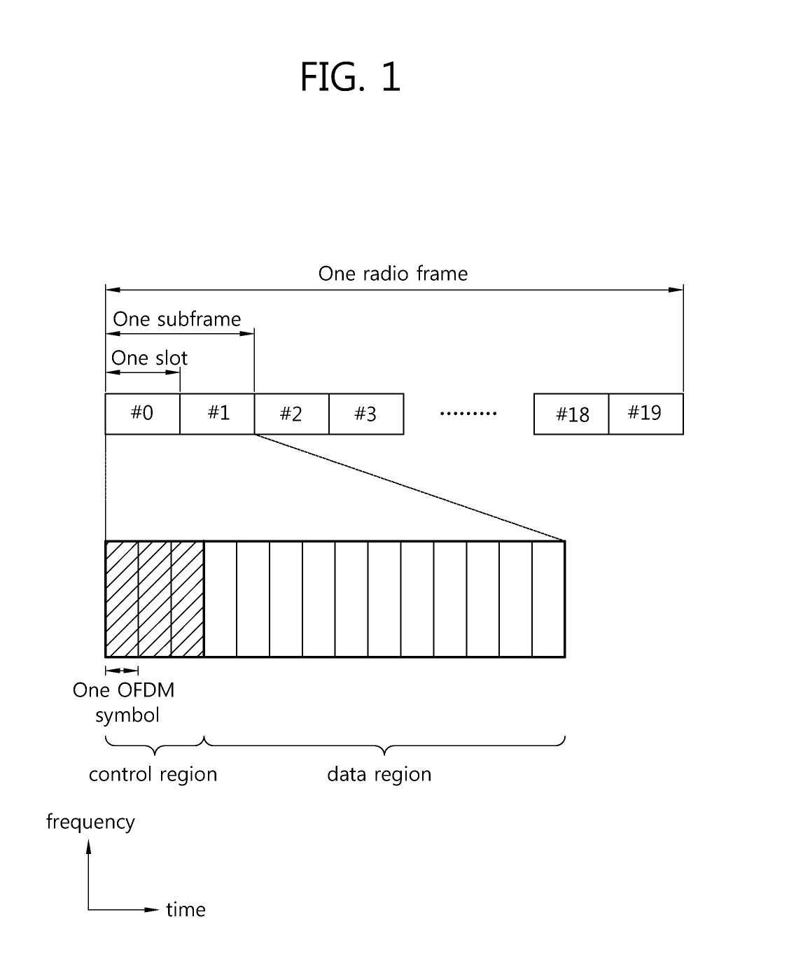

FIG. 1 shows a structure of a DL radio frame in 3GPP LTE-A. The section 6 of 3GPP TS 36.211 V10.2.0 (2011-06) “Evolved Universal Terrestrial Radio Access (E-UTRA); Physical Channels and Modulation (Release 10)” may be incorporated herein by reference.

A radio frame includes 10 subframes indexed with 0 to 9. One subframe includes 2 consecutive slots. A time required for transmitting one subframe is defined as a transmission time interval (TTI). For example, one subframe may have a length of 1 millisecond (ms), and one slot may have a length of 0.5 ms.

One slot may include a plurality of orthogonal frequency division multiplexing (OFDM) symbols in a time domain. Since the 3GPP LTE uses orthogonal frequency division multiple access (OFDMA) in a downlink (DL), the OFDM symbol is only for expressing one symbol period in the time domain, and there is no limitation in a multiple access scheme or terminologies. For example, the OFDM symbol may also be referred to as another terminology such as a single carrier frequency division multiple access (SC-FDMA) symbol, a symbol period, etc.

Although it is described that one slot includes 7 OFDM symbols for example, the number of OFDM symbols included in one slot may vary depending on a length of a cyclic prefix (CP). According to 3GPP TS 36.211 V10.2.0, in case of a normal CP, one slot includes 7 OFDM symbols, and in case of an extended CP, one slot includes 6 OFDM symbols.

A resource block (RB) is a resource allocation unit, and includes a plurality of subcarriers in one slot. For example, if one slot includes 7 OFDM symbols in a time domain and the RB includes 12 subcarriers in a frequency domain, one RB can include 7□12 resource elements (REs).

A DL subframe is divided into a control region and a data region in the time domain. The control region includes up to first four OFDM symbols of a first slot in the subframe. However, the number of OFDM symbols included in the control region may vary. A physical downlink control channel (PDCCH) and other control channels are allocated to the control region, and a physical downlink shared channel (PDSCH) is allocated to the data region.

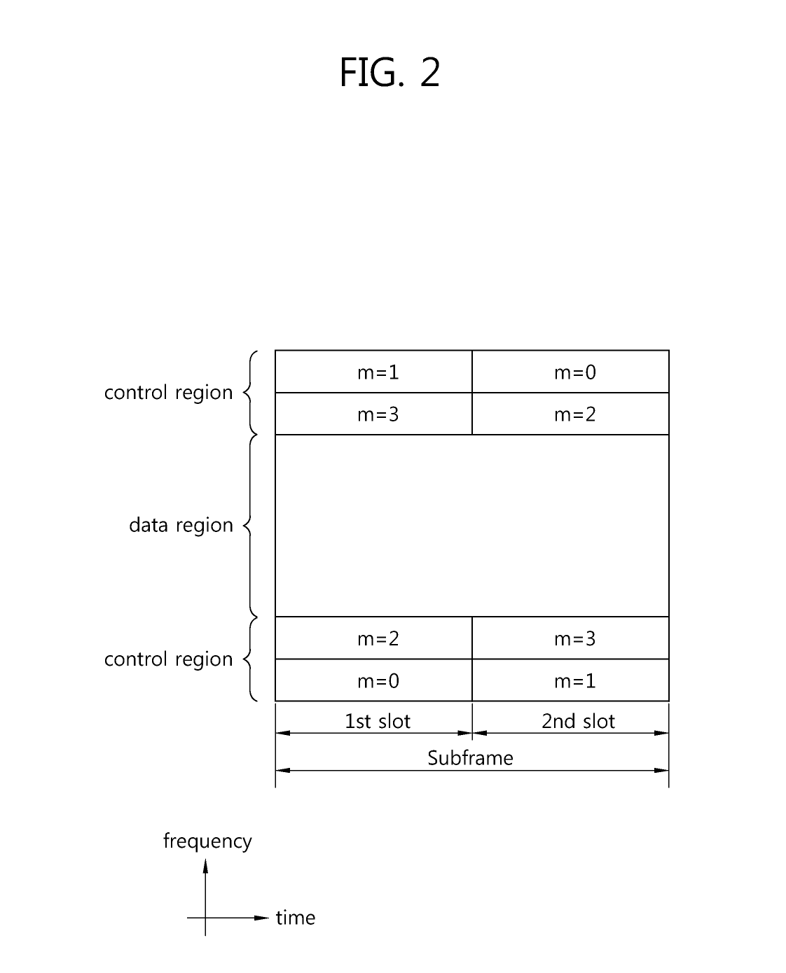

FIG. 2 shows a structure of a UL subframe in 3GPP LTE-A.

The UL subframe can be divided into a control region and a data region. The control region is a region to which a physical uplink control channel (PUCCH) carrying UL control information is allocated. The data region is a region to which a physical uplink shared channel (PUSCH) carrying user data is allocated.

The PUCCH is allocated in an RB pair in a subframe. RBs belonging to the RB pair occupy different subcarriers in each of a 1st slot and a 2nd slot. m is a location index indicating a logical frequency-domain location of the RB pair allocated to the PUCCH in the subframe. It shows that RBs having the same value m occupy different subcarriers in the two slots.

Now, a DL control channel is described.

As disclosed in 3GPP TS 36.211 V10.2.0, examples of a physical control channel in 3GPP LTE/LTE-A include a physical downlink control channel (PDCCH), a physical control format indicator channel (PCFICH), and a physical hybrid-ARQ indicator channel (PHICH).

The PCFICH transmitted in a 1st OFDM symbol of the subframe carries a control format indicator (CFI) regarding the number of OFDM symbols (i.e., a size of the control region) used for transmission of control channels in the subframe. The UE first receives the CFI on the PCFICH, and thereafter monitors the PDCCH.

Unlike the PDCCH, the PCFICH does not use blind decoding, and is transmitted by using a fixed PCFICH resource of the subframe.

The PHICH carries a positive-acknowledgement (ACK)/negative-acknowledgement (NACK) signal for an uplink hybrid automatic repeat request (HARQ). The ACK/NACK signal for uplink (UL) data on a PUSCH transmitted by the UE is transmitted on the PHICH.

A physical broadcast channel (PBCH) is transmitted in first four OFDM symbols in a second slot of a first subframe of a radio frame. The PBCH carries system information necessary for communication between the UE and the BS. The system information transmitted through the PBCH is referred to as a master information block (MIB). In comparison thereto, system information transmitted on the PDCCH is referred to as a system information block (SIB).

Control information transmitted through the PDCCH is referred to as downlink control information (DCI). The DCI may include resource allocation of the PDSCH (this is referred to as a downlink (DL) grant), resource allocation of a PUSCH (this is referred to as an uplink (UL) grant), a set of transmit power control commands for individual UEs in any UE group, and/or activation of a voice over Internet protocol (VoIP).

The 3GPP LTE/LTE-A uses blind decoding for PDCCH detection. The blind decoding is a scheme in which a desired identifier is de-masked from a cyclic redundancy check (CRC) of a received PDCCH (referred to as a candidate PDCCH) to determine whether the PDCCH is its own control channel by performing CRC error checking.

The BS determines a PDCCH format according to DCI to be transmitted to the UE, attaches a CRC to the DCI, and masks a unique identifier (referred to as a radio network temporary identifier (RNTI)) to the CRC according to an owner or usage of the PDCCH.

A control region in a subframe includes a plurality of control channel elements (CCEs). The CCE is a logical allocation unit used to provide the PDCCH with a coding rate depending on a radio channel state, and corresponds to a plurality of resource element groups (REGs). The REG includes a plurality of resource elements. According to an association relation of the number of CCEs and the coding rate provided by the CCEs, a PDCCH format and the number of bits of an available PDCCH are determined.

One REG includes 4 REs. One CCE includes 9 REGs. The number of CCEs used to configure one PDCCH may be selected from a set {1, 2, 4, 8}. Each element of the set {1, 2, 4, 8} is referred to as a CCE aggregation level.

The BS determines the number of CCEs used in transmission of the PDCCH according to a channel state. For example, a UE having a good downlink channel state can use one CCE in PDCCH transmission. A UE having a poor downlink channel state can use 8 CCEs in PDCCH transmission.

A control channel consisting of one or more CCEs performs interleaving in an REG unit, and is mapped to a physical resource after performing cyclic shift based on a cell identifier (ID).

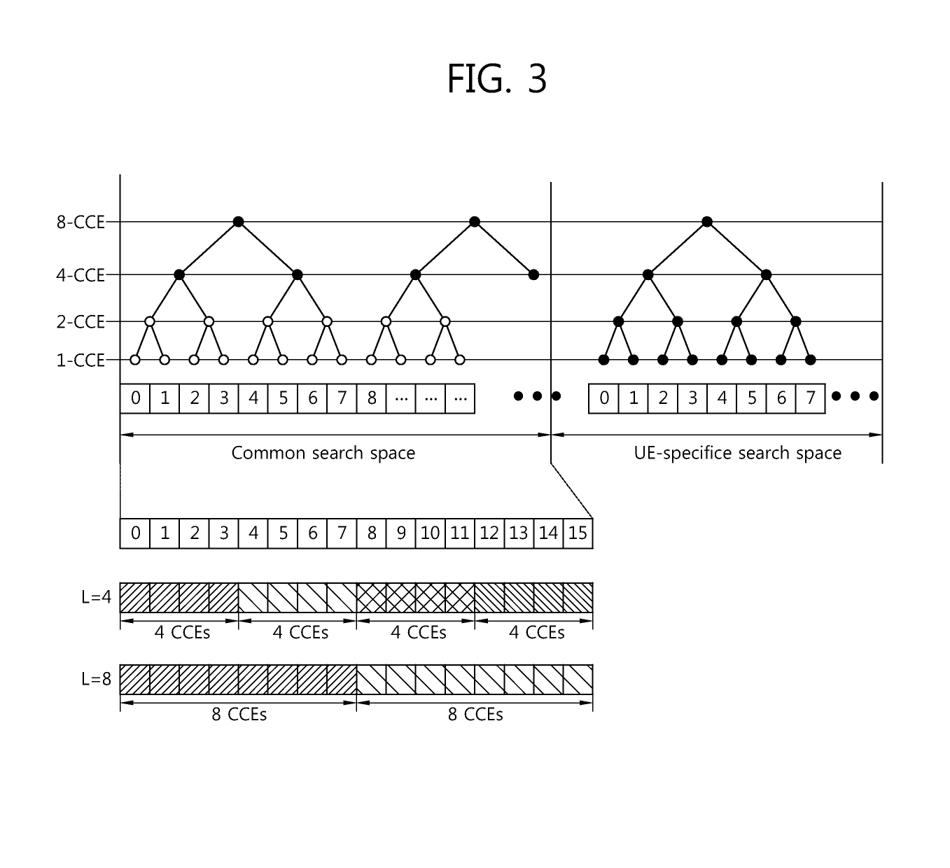

FIG. 3 shows an example of monitoring a PDCCH. The section 9 of 3GPP TS 36.213 V10.2.0 (2011-06) may be incorporated herein by reference.

3GPP LTE uses blind decoding to detect the PDCCH. The blind decoding is a scheme in which a specific identifier is de-masked from a CRC of received PDCCH (referred to as candidate PDCCH) data and thereafter whether the PDCCH is its own control channel is determined by performing CRC error checking. The UE cannot know about a specific position in a control region in which its PDCCH data is transmitted and about a specific CCE aggregation level or DCI format used in transmission.

A plurality of PDCCHs may be transmitted in one subframe. The UE monitors the plurality of PDCCHs in every subframe. Herein, monitoring is an operation in which the UE attempts to perform blind decoding on the PDCCH.

The 3GPP LTE uses a search space to reduce an overload caused by the blind decoding. The search space may also be called a monitoring set of a CCE for the PDCCH. The UE monitors the PDCCH within a corresponding search space.

The search space is classified into a common search space and a UE-specific search space. The common search space is a space for searching for a PDCCH having common control information and consists of 16 CCEs indexed with 0 to 15. The common search space supports a PDCCH having a CCE aggregation level of {4, 8}. However, a PDCCH (e.g., DCI formats 0, 1A) for carrying UE-specific information may also be transmitted in the common search space. The UE-specific search space supports a PDCCH having a CCE aggregation level of {1, 2, 4, 8}.

Table 1 shows the number of PDCCH candidates monitored by the UE.

TABLE 1

| | | | Number of | |
|---|---|---|---|---|
| Search Space | Aggregation | Size [in | PDCCH | |
| Type | level L | CCEs] | candidates | DCI formats |
| UE-specific | 1 | 6 | 6 | 0, 1, |
| | 2 | 12 | 6 | 1A, 1B, 1D, 2, |
| | 4 | 8 | 2 | 2A |
| | 8 | 16 | 2 | |
| Common | 4 | 16 | 4 | 0, 1A, 1C, |
| | 8 | 16 | 2 | 3/3A |

A size of search space is determined by Table 1 above, and a starting position of the search space is defined differently in the common search space and the UE-specific search space. Although a starting position of the common search space is fixed irrespective of a subframe, a starting position of the UE-specific search space may vary in every subframe according to a UE identifier (e.g., C-RNTI), a CCE aggregation level, and/or a slot number in a radio frame. If the starting position of the UE-specific search space exists in the common search space, the UE-specific search space and the common search space may overlap.

In an aggregation level Lε{1, 2, 3, 4}, a search space S^{(L)}ₖ is defined as the set of PDCCH candidates. In the search space S^{(L)}ₖ, a CCE corresponding to a PDCCH candidate m is given by Equation 1 below.

L·{(Yₖ+m′)mod └N_{CCE,k}/L┘}+i [Equation 1]

Herein, i=0, 1, . . . , L−1, m=0, . . . , M^{(L)}−1. N_{CCE,k} denotes the total number of CCEs that can be used in transmission of a PDCCH in a control region of a subframe k. The control region includes a set of CCEs numbered from 0 to N_{CCE,k}−1. M^{(L)} is the number of PDCCH candidates in a CCE aggregation level L of a given search space.

If a carrier indicator field (CIF) is set to the UE, m′=m+M^{(L)}n_{cif}. Herein, n_{cif} is a value of the CIF. If the CIF is not set to the UE, m′=m.

In a common search space, Yₖ is set to 0 with respect to two aggregation levels L=4 and L=8.

In a UE-specific search space of the aggregation level L, a variable Yₖ is defined by Equation 2 below.

Yₖ=(A·Yₖ₋₁)mod D [Equation 2]

Herein, Y₋₁=n_{RNTI}≠0, A=39827, D=65537, k=floor(nₛ/2). nₛ denotes a slot number in a radio frame.

In 3GPP LTE/LTE-A, transmission of a DL transport block is performed in a pair of the PDCCH and the PDSCH. Transmission of a UL transport block is performed in a pair of the PDCCH and the PUSCH. For example, the UE receives the DL transport block on a PDSCH indicated by the PDCCH. The UE receives a DL resource assignment on the PDCCH by monitoring the PDCCH in a DL subframe. The UE receives the DL transport block on a PDSCH indicated by the DL resource assignment.

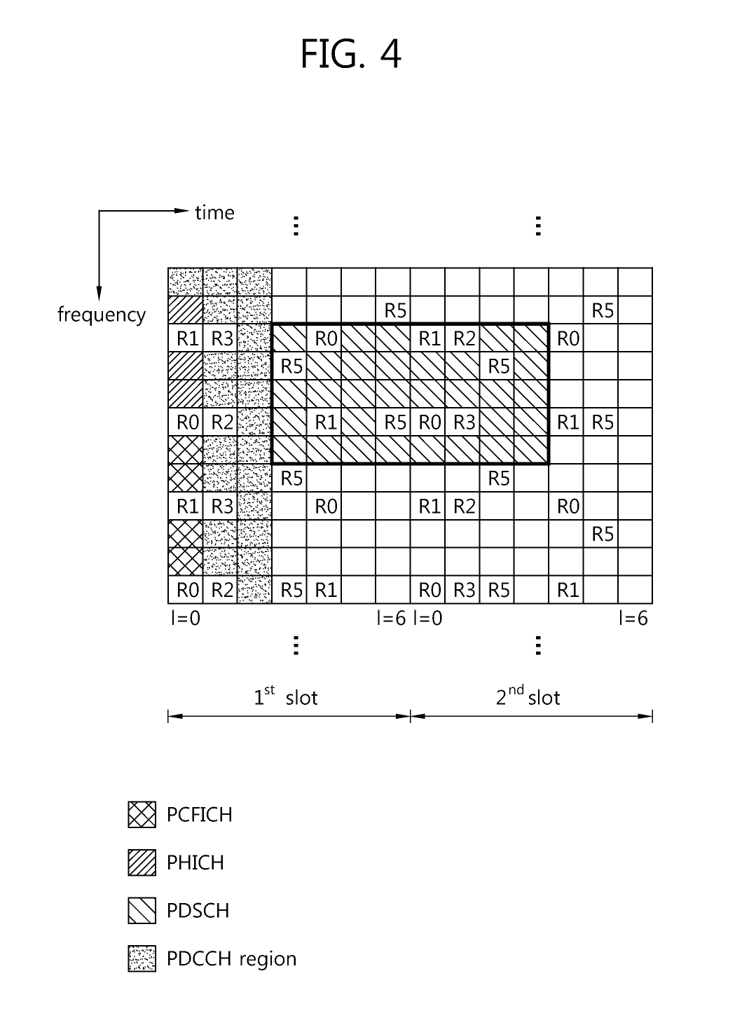

FIG. 4 shows an example of displaying a reference signal and a control channel in a DL subframe.

A control region includes first three OFDM symbols, and a data region in which a PDSCH is transmitted includes the remaining OFDM symbols.

A PCFICH, a PHICH, and/or a PDCCH are transmitted in the control region. A control format indictor (CFI) of the PCFICH indicates three OFDM symbols. A region excluding a resource in which the PCFICH and/or the PHICH are transmitted in the control region is a PDCCH region in which the UE monitors the PDCCH.

Various reference signals are transmitted in the subframe.

A cell-specific reference signal (CRS) may be received by all UEs in a cell, and is transmitted across a full downlink frequency band. In FIG. 4, ‘R0’ indicates a resource element (RE) used to transmit a CRS for a first antenna port, ‘R1’ indicates an RE used to transmit a CRS for a second antenna port, ‘R2’ indicates an RE used to transmit a CRS for a third antenna port, and ‘R3’ indicates an RE used to transmit a CRS for a fourth antenna port.

An RS sequence r_{l,ns}(m) for a CRS is defined as follows.

$${r}_{l , n s} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \qquad [ Equation 3 ]$$

Herein, m=0, 1, . . . , 2N_{maxRB}−1. N_{maxRB} is the maximum number of RBs. ns is a slot number in a radio frame. l is an OFDM symbol index in a slot.

A pseudo-random sequence c(i) is defined by a length-31 gold sequence as follows.

c(n)=(x₁(n+Nc)+x₂(n+Nc))mod 2

x₁(n+31)=(x₁(n+3)+x₁(n))mod 2

x₂(n+31)=(x₂(n+3)+x₂(n+2)+x₂(n+1)+x₂(n))mod 2 [Equation 4]

Herein, Nc=1600, and a first m-sequence is initialized as x₁(0)=1, x₁(n)=0, m=1, 2, . . . , 30.

A second m-sequence is initialized as cᵢₙᵢₜ=2¹⁰(7(ns+1)+l+1)(2N^{cell}_{ID}+1)+2N^{cell}_{ID}+N_{CP} at a start of each OFDM symbol. N^{cell}_{ID} is a physical cell identifier (PCI). N_{CP}=1 in a normal CP case, and N_{CP}=0 in an extended CP case.

A UE-specific reference signal (URS) is transmitted in the subframe. Whereas the CRS is transmitted in the entire region of the subframe, the URS is transmitted in a data region of the subframe and is used to demodulate the PDSCH. In FIG. 4, ‘R5’ indicates an RE used to transmit the URS. The URS is also called a dedicated reference signal (DRS) or a demodulation reference signal (DM-RS).

The URS is transmitted only in an RB to which a corresponding PDSCH is mapped. Although R5 is indicated in FIG. 4 in addition to a region in which the PDSCH is transmitted, this is for indicating a location of an RE to which the URS is mapped.

The URS is used only by a UE which receives a corresponding PDSCH. A reference signal (RS) sequence rₙₛ(m) for the URS is equivalent to Equation 3. In this case, m=0, 1, . . . , 12N_{PDSCH,RB}−1, and N_{PDSCH,RB} is the number of RBs used for transmission of a corresponding PDSCH. A pseudo-random sequence generator is initialized as cᵢₙᵢₜ=(floor(ns/2)+1)(2N^{cell}_{ID}+1)2¹⁶+n_{RNTI} at a start of each subframe. n_{RNTI} is a UE identifier.

The aforementioned initialization method is for a case where the URS is transmitted through the single antenna, and when the URS is transmitted through multiple antennas, the pseudo-random sequence generator is initialized as cᵢₙᵢₜ=(floor(ns/2)+1)(2N^{cell}_{ID}+1)2¹⁶+n_{SCID} at a start of each subframe. n_{SCID} is a parameter acquired from a DL grant (e.g., a DCI format 2B or 2C) related to PDSCH transmission.

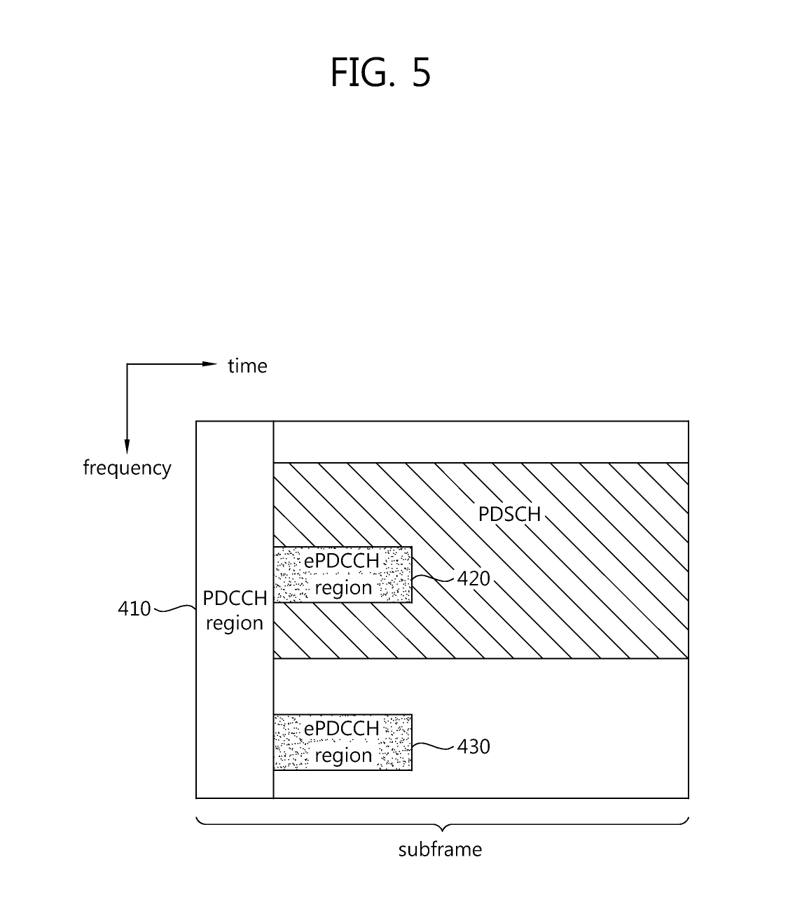

FIG. 5 shows an example of a subframe having an extended PDCCH.

The legacy 3GPP LTE/LTE-A system has a limitation in that a PDCCH which carries a variety of control information such as DL/UL scheduling, etc., is transmitted only in a control region of a subframe. Therefore, there is ongoing discussion on the introduction of an extended-PDCCH (ePDCCH) which is more flexibly scheduled. The ePDCCH is also called an enhanced-PDCCH.

The subframe includes a PDCCH region 410 for monitoring a PDCCH and one or more ePDCCH regions 420 and 430 in which the ePDCCH is monitored.

The PDCCH region 410 is located in up to first four OFDM symbols of the subframe, whereas the ePDCCH regions 420 and 430 may be flexibly scheduled in a data region.

In the PDCCH region 410, a PDCCH may be demodulated according to a CRS. In the ePDCCH regions 420 and 430, the ePDCCH may be demodulated according to a URS. The URS may be transmitted in corresponding ePDCCH regions 420 and 430.

The ePDCCH regions 420 and 430 may use blind decoding to monitor the ePDCCH. Alternatively, the ePDCCH may not use the blind decoding. A UE may know in advance a location or the number of ePDCCHs in the ePDCCH regions 420 and 430 and detect the ePDCCH at a designated location.

The ePDCCH regions 420 and 430 may be monitored by one UE, a UE group, or UEs in a cell. If a specific UE monitors the ePDCCH regions 420 and 430, n_{RNTI} or n_{SCID} which is used to initialize a pseudo-random sequence generator of the URS may be obtained on the basis of an identifier of the specific UE. If a UE group monitors the ePDCCH regions 420 and 430, n_{RNTI} or n_{SCID} which is used to initialize a pseudo-random sequence generator of the URS may be obtained on the basis of an identifier of the UE group.

When the ePDCCH regions 420 and 430 are transmitted through multiple antennas, the same precoding as that of the URS may be applied to the ePDCCH regions 420 and 430.

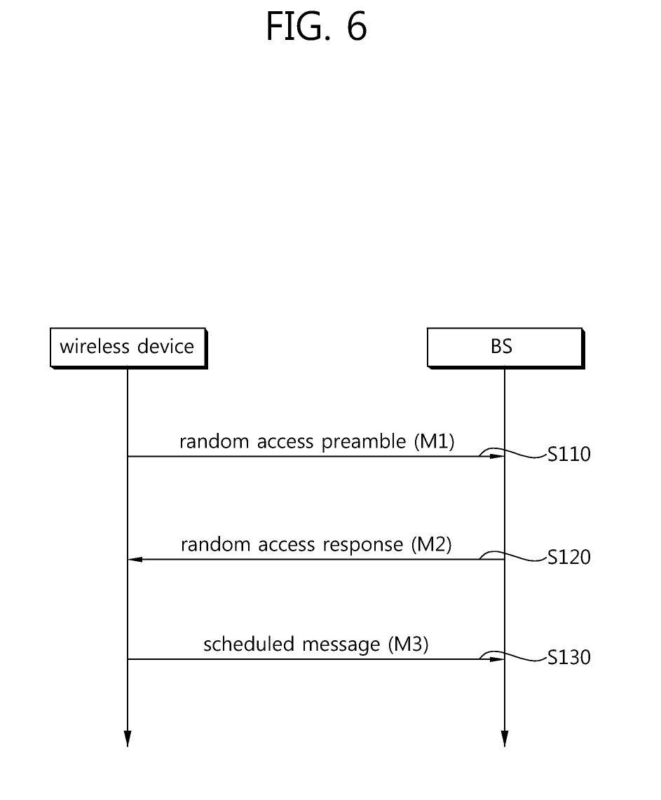

FIG. 6 is a flowchart showing the conventional random access procedure. The random access procedure is used by a wireless device to acquire a UL time alignment with a BS or to allocate a UL radio resource.

The wireless device receives a root index and a physical random access channel (PRACH) configuration index from the BS. Each cell has 64 candidate random access preambles defined by a Zadoff-Chu (ZC) sequence, the root index is a logical index for generating the 64 candidate random access preambles by the wireless device.

The random access preamble is limited to a specific time and frequency resource for each cell. The PRACH configuration index indicates a specific subframe and preamble format capable of transmitting the random access preamble.

Table 2 below shows an example of the random access configuration disclosed in the section 5.7 of 36.211 V10.2.0 (2011-06).

TABLE 2

| PRACH | Preamble | System | Subframe |
|---|---|---|---|
| configuration index | format | frame number | number |
| 0 | 0 | Even | 1 |
| 1 | 0 | Even | 4 |
| 2 | 0 | Even | 7 |
| 3 | 0 | Any | 1 |
| 4 | 0 | Any | 4 |
| 5 | 0 | Any | 7 |
| 6 | 0 | Any | 1, 6 |

The wireless device transmits a randomly selected random access preamble to the BS (step S110). The wireless device selects one of the 64 candidate random access preambles. In addition, the wireless device selects a corresponding subframe by using the PRACH configuration index. The wireless device transmits the selected random access preamble in the selected subframe.

Upon receiving the random access preamble, the BS transmits a random access response (RAR) to the wireless device (step S120). The RAR is detected in two steps. First, the wireless device detects a PDCCH masked with a random access-RNTI (RA-RNTI). The wireless device receives the RAR included in a medium access control (MAC) protocol data unit (PDU) through a PDSCH indicated by the detected PDCCH.

The RAR may include a timing advance command (TAC), a UL grant, and a temporary C-RNTI. The TAC is information indicating a time alignment value sent by a BS to a wireless device to maintain a UL time alignment. The wireless device updates UL transmission timing by using the time alignment value. When the wireless device updates the time alignment, a time alignment timer starts or restarts. The wireless device can perform UL transmission only when the time alignment timer is running.

The wireless device transmits a scheduled message to the BS according to a UL grant included in the RAR (step S130).

Hereinafter, the random access preamble, the RAR, and the scheduled message are respectively called messages M1, M2, and M3.

Now, the proposed method of supporting various bandwidths is described.

First, a wireless device may report to a BS about a bandwidth capability related to an operating bandwidth supported by the wireless device itself.

The operating bandwidth may imply one or more bandwidths at which the wireless device can operate or a maximum bandwidth.

The bandwidth capability may include at least one of the followings.

(1) Information reporting that a bandwidth supported by the wireless device is smaller than a bandwidth supported by the BS.

(2) Information reporting that the wireless device can operate in a specific bandwidth.

(3) Information regarding a list of supportable bandwidths.

Hereinafter, a bandwidth basically supported by the BS is called a reference bandwidth. An operating bandwidth of the wireless device is smaller than the reference bandwidth. For example, the reference bandwidth may be any one of 20 MHz, 10 MHz, and 5 MHz. The operating bandwidth may be any one of 5 MHz, 3 MHz, and 1.4 MHz. Although the bandwidth can be represented in a unit of MHz, this is for exemplary purposes only, and thus may also be represented in various units which represent a frequency domain such as the number of RBs, the number of subcarriers, etc.

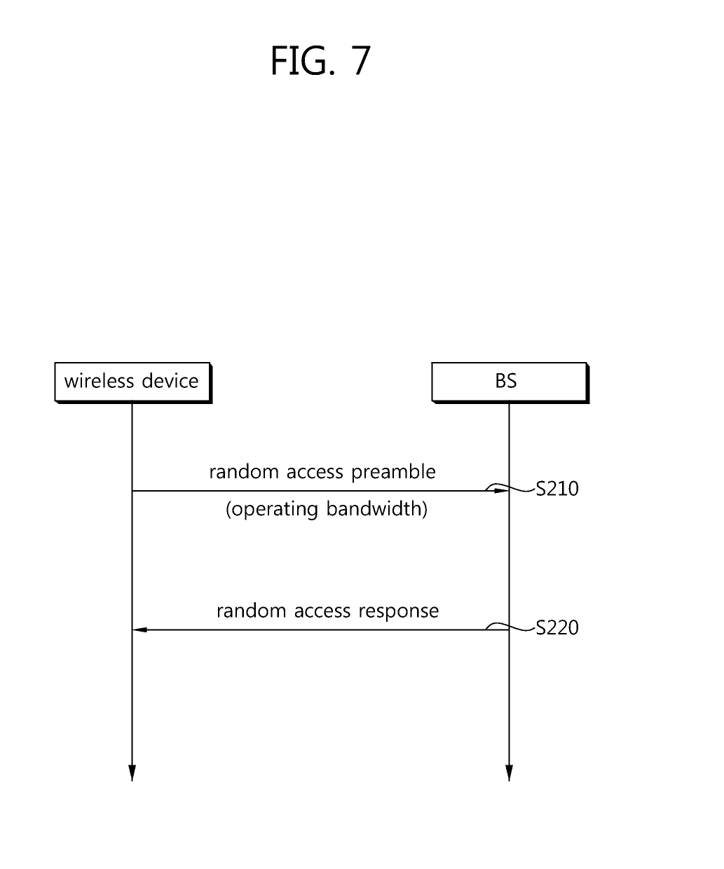

FIG. 7 shows a random access procedure according to an embodiment of the present invention. The random access procedure is utilized when information regarding an operating bandwidth of a wireless device is reported to a BS.

The wireless device transmits a random access preamble indicating the operating bandwidth to the BS (step S210). The random access preamble may be transmitted on the basis of a reference bandwidth so that the BS can receive the random access preamble.

In one embodiment, the random access preamble may be designated according to an operating bandwidth. For example, 64 candidate random access preambles may be divided into two or more groups, and each group may be used distinctively according to the operating bandwidth. A first group may be used by a wireless device which uses the reference bandwidth, and a second group may be used by a wireless device which uses an operating bandwidth of a narrowband. A plurality of groups may change depending on a predetermined rule according to a time or a frequency.

In another embodiment, a resource (i.e., a subframe, an RB location, etc.) used to transmit the random access preamble may be designated according to the operating bandwidth. For example, among the PRACH configuration indices of Table 2, indices 0 to 5 may be used by the wireless device which uses the reference bandwidth, and the PRACH configuration index 6 may be used by the wireless device which uses the operating bandwidth of the narrowband.

Alternatively, in the PRACH configuration, a specific RB or a specific subframe may be used to indicate the operating bandwidth. For example, assume that the PRACH configuration index 6 is configured. The wireless device which uses the reference bandwidth may transmit the random access preamble in a subframe having a subframe number 1 and/or 6. The wireless device which uses the operating bandwidth may transmit the random access preamble only in the subframe having the subframe number 6.

The random access preamble may be transmitted in a specific RB indicating the operating bandwidth.

A resource for indicating the operating bandwidth may change depending on a predetermined rule according to a time.

The random device receives the random access response from the BS (step S220). The random access response may include information which allows or denies the use of the operating bandwidth.

On the basis of a UL grant of the random access response, the wireless device may transmit a scheduled message. The scheduled message may include information regarding a bandwidth capability of the wireless device.

The wireless device may use the random access preamble to report that the wireless device itself uses the operating bandwidth of the narrowband, and may transmit more specific information (e.g., a size or location of the operating bandwidth) through the scheduled message or an RRC message.

The information indicating the operating bandwidth of the wireless device may be included in a message on a PUSCH or may be transmitted through CRC scrambling, bit scrambling, etc.

The wireless device may transmit information regarding a bandwidth capability to the BS in an initial access procedure and a connection reconfiguration procedure with respect to the BS.

The operating bandwidth may be independent of a DL operation and a UL operation. The wireless device may report at least one of a DL operating bandwidth and a UL operating bandwidth to the BS. Since it is easier to limit a UL bandwidth than to limit a DL bandwidth, only the UL operating bandwidth may be reported. The wireless device may use a reference bandwidth to perform DL communication, and may use an operating bandwidth to perform UL communication.

Now, it is described an operation at an operating bandwidth after a negotiation of the operating bandwidth is complete.

A wireless device operating at an operating bandwidth of a narrowband may perform PDCCH/PDSCH/PUSCH scheduling only in a portion of a reference bandwidth of a broadband. Such a band limitation may be applied to all subframes, or may be applied only to a specific subframe. A subframe to which the operating bandwidth is applied (such a frame is called an operating subframe) may be predetermined, or may be reported by the BS to the wireless device through RRC signaling.

In a 3GPP LTE/LTE-A system, the wireless device may monitor a PDCCH at a reference bandwidth in a subframe in which system information (e.g., SIB-1) is transmitted or a subframe in which a paging message is transmitted. In addition, the wireless device may monitor the PDCCH at the reference bandwidth during an initial access.

Since a PCFICH which reports a size of a PDCCH region in each subframe is transmitted in a distributed manner across a full system band, the PCFICH cannot be received if the wireless device operates at a limited operating bandwidth. Therefore, the BS may report to the wireless device about information regarding a size of the PDCCH region (e.g., the number of OFDM symbols for the PDCCH region) or information regarding a location of an OFDM symbol in which PDSCH transmission starts.

The PDCCH region may not be defined in the operating subframe to which the operating bandwidth is applied. That is, the PDSCH may be transmitted at a first OFDM symbol of a subframe.

A different bandwidth may be assigned independently as an operating bandwidth to each wireless device at a reference bandwidth.

The PDCCH of 3GPP LTE/LTE-A has a structure in which it is transmitted in a distributed manner across a full system band. Therefore, there is a problem in that the wireless device operating at the operating bandwidth cannot receive the legacy PDCCH.

Therefore, DL/UL scheduling and other control signaling of the wireless device operating at the operating bandwidth may be performed through an ePDCCH.

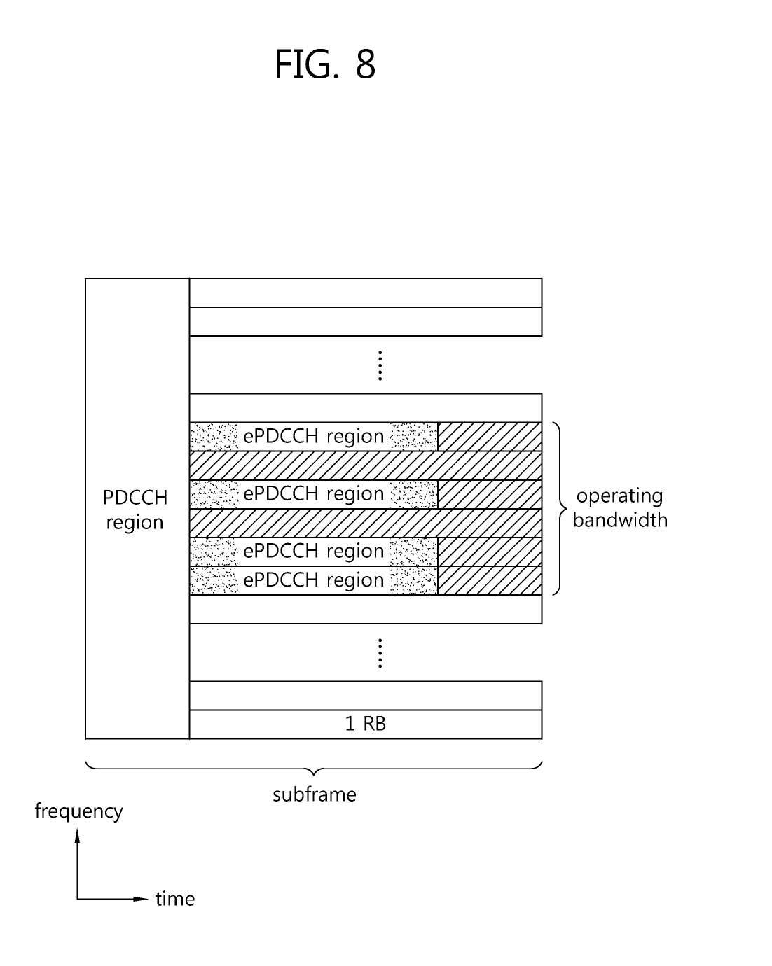

FIG. 8 shows scheduling using an ePDCCH.

An operating bandwidth of a wireless device is 6 RBs, and an ePDCCH region for the wireless device is defined within the 6 RBs. The wireless device may monitor the ePDCCH in the ePDCCH region.

Resource allocation on the ePDCCH may be defined on the basis of the RB within the operating bandwidth. For example, if a DL operating bandwidth is 6 RBs, resource allocation may include a 6-bit bitmap corresponding to the 6 RBs. For example, if the bitmap is ‘100100’, it indicates that a 1st RB and a 4th RB are allocated to PDSCH transmission.

A BS may report to the wireless device about a size or location of a DL/UL operating bandwidth at which the wireless device operates. The operating bandwidth may be used to receive both of PDCCH/PDSCH. Alternatively, the PDCCH may be received at a reference bandwidth, and the PDSCH may be received at an operating bandwidth. The operating bandwidth may be limited in data traffic reception.

Now, reception of system information is described.

The system information refers to information necessary for communication between a wireless device and a BS. According to 3GPP LTE/LTE-A, the system information is transmitted through a PDSCH scheduled through a PDCCH. However, since a wireless device operating at an operating bandwidth cannot receive the PDCCH which is transmitted in a distributed manner across a reference bandwidth, there is a need for a method capable of receiving the system information by the wireless device.

For wireless devices operating at the operating bandwidth, the BS may transmit system information through a PDSCH transmitted through RBs within a specific bandwidth. That is, system information is transmitted on a reference bandwidth, and the same system information is transmitted on a narrowband. The PDSCH for carrying the system information may be scheduled through the ePDCCH within the operating bandwidth, or may be transmitted through a predetermined subframe and/or RB without the ePDCCH.

When the system information is scheduled through the PDCCH, the ePDCCH may be monitored in the ePDCCH region which is common to a plurality of wireless devices.

Now, transmission of UL control information is described.

In 3GPP LTE/LTE-A, a PUCCH is used to transmit an HARQ ACK/NACK, a channel status indication (CSI), and a scheduling request (SR). As illustrated in FIG. 2, the PUCCH is allocated sequentially from an outermost RB of a reference bandwidth to an inner side.

For example, assume that the reference bandwidth includes 20 RBs indexed from 0 to 19. RBs used by the PUCCH start from RBs indexed with 0 and 19. However, if an operating bandwidth is defined as 6 RBs indexed with 10 to 15, a wireless device may be unable to transmit the PUCCH.

Therefore, it is proposed to define a starting position of a PUCCH resource for a wireless device operating at an operating bandwidth.

If the operating bandwidth is defined for each wireless device, the PUCCH starting position may be defined for each wireless device. The PUCCH starting position may be delivered through RRC signaling.

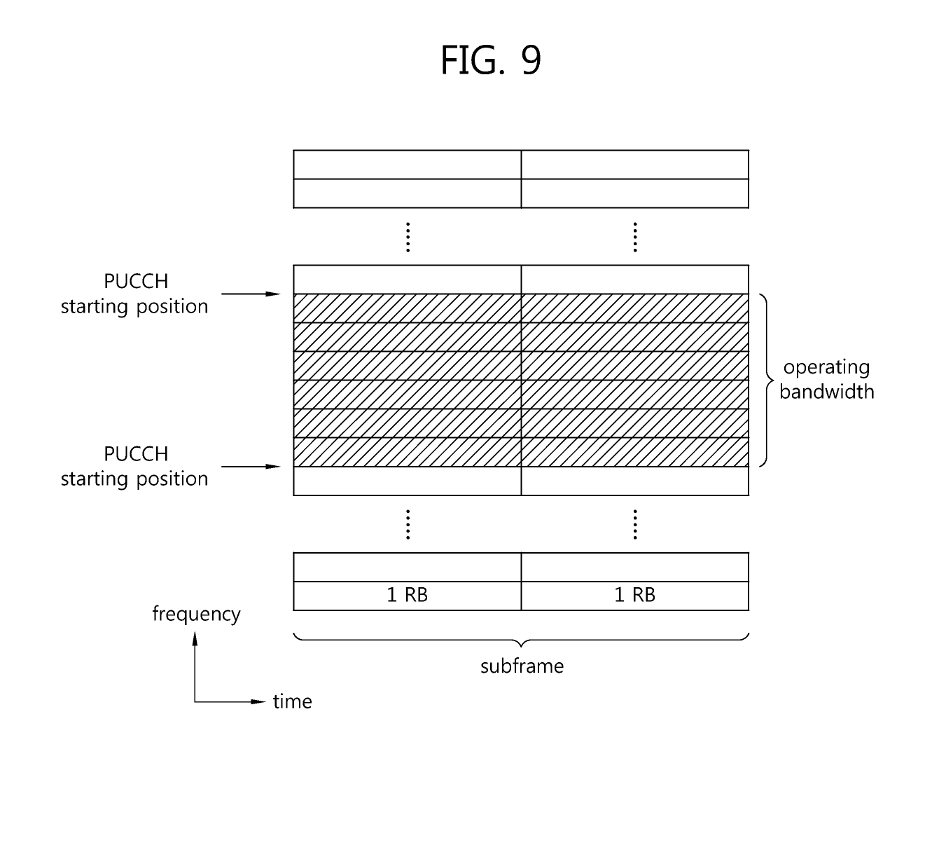

FIG. 9 shows an example of PUCCH resource allocation at an operating bandwidth.

A PUCCH starting position indicates an RB in which the PUCCH starts to be allocated. If the operating bandwidth is defined as 6 RBs indexed with 10 to 15, the PUCCH starting position may indicate an RB indexed with 10 and/or an RB indexed with 15.

The PUCCH starting position may be given as an offset starting from a lowest (or highest) RB index of a reference bandwidth.

The PUCCH starting position or the PUCCH resource within the UL operating bandwidth may be related with a resource of a corresponding ePDCCH. For example, upon receiving a PDSCH indicated by an ePDCCH candidate 1, the wireless device may transmit ACK/NACK for a PDSCH by using a PUCCH resource corresponding to the ePDCCH candidate 1.

Only one RB may be allocated for the PUCCH at the operating bandwidth. In this case, the same RB may be used for PUCCH transmission in two slots.

Information regarding the PUCCH starting position may be delivered to the wireless device through RRC signaling.

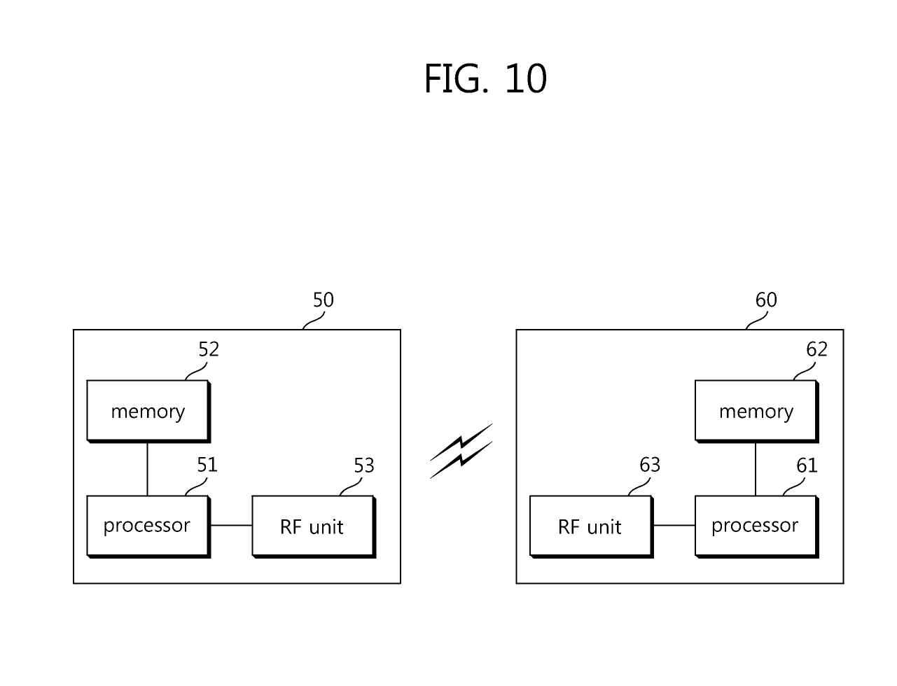

FIG. 10 is a block diagram of a wireless communication system according to an embodiment of the present invention.

ABS 50 includes a processor 51, a memory 52, and a radio frequency (RF) unit 53. The memory 52 is coupled to the processor 51, and stores a variety of information for driving the processor 51. The RF unit 53 is coupled to the processor 51, and transmits and/or receives a radio signal. The processor 51 implements the proposed functions, procedures, and/or methods. In the aforementioned embodiment, an operation of the BS may be implemented by the processor 51.

A wireless device 60 includes a processor 61, a memory 62, and an RF unit 63. The memory 62 is coupled to the processor 61, and stores a variety of information for driving the processor 61. The RF unit 63 is coupled to the processor 61, and transmits and/or receives a radio signal. The processor 61 implements the proposed functions, procedures, and/or methods. In the aforementioned embodiment, an operation of the wireless device may be implemented by the processor 61.

The processor may include an application-specific integrated circuit (ASIC), a separate chipset, a logic circuit, and/or a data processing unit. The memory may include a read-only memory (ROM), a random access memory (RAM), a flash memory, a memory card, a storage medium, and/or other equivalent storage devices. The RF unit may include a baseband circuit for processing a radio signal. When the embodiment of the present invention is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

Although the aforementioned exemplary system has been described on the basis of a flowchart in which steps or blocks are listed in sequence, the steps of the present invention are not limited to a certain order. Therefore, a certain step may be performed in a different step or in a different order or concurrently with respect to that described above. Further, it will be understood by those ordinary skilled in the art that the steps of the flowcharts are not exclusive. Rather, another step may be included therein or one or more steps may be deleted within the scope of the present invention.

What is claimed is:

1. A communication method supporting a variable bandwidth in a wireless communication system, the method comprising:
transmitting by a wireless device a random access preamble indicating an operating bandwidth to a base station supporting a reference bandwidth; and
receiving by the wireless device a random access response from the base station in response to the random access preamble,
wherein the operating bandwidth is smaller than the reference bandwidth.

2. The method of claim 1,
wherein a plurality of candidate random access preambles are divided into a first group and a second group, and the first group indicates the reference bandwidth and the second group indicates the operating bandwidth, and
wherein the random access preamble is randomly selected from candidate random access preambles included in the second group.

3. The method of claim 1, wherein the operating bandwidth is indicated according to a resource for transmitting the random access preamble.

4. The method of claim 3, wherein the resource is a subframe.

5. The method of claim 1, further comprising:
receiving a control channel for scheduling a data channel at the reference bandwidth; and
receiving the data channel at the operating bandwidth.

6. The method of claim 1, further comprising:
receiving a control channel for scheduling a data channel at the operating bandwidth; and
receiving the data channel at the operating bandwidth.

7. The method of claim 6, wherein the control channel uses the same reference signal as that of the data channel.

8. The method of claim 1, wherein the random access response includes information which allows the use of the operating bandwidth.

9. A wireless device supporting a variable bandwidth in a wireless communication system, the wireless device comprising:
a radio frequency (RF) unit for transmitting and receiving a radio signal; and
a processor operatively coupled to the RF unit, wherein the processor is configured for:
transmitting a random access preamble indicating an operating bandwidth to a base station supporting a reference bandwidth; and
receiving a random access response from the base station in response to the random access preamble,
wherein the operating bandwidth is smaller than the reference bandwidth.

10. The wireless device of claim 9,
wherein a plurality of candidate random access preambles are divided into a first group and a second group, and the first group indicates the reference bandwidth and the second group indicates the operating bandwidth, and
wherein the random access preamble is randomly selected from candidate random access preambles included in the second group.

11. The wireless device of claim 9, wherein the operating bandwidth is indicated according to a resource for transmitting the random access preamble.

12. The wireless device of claim 9, wherein the processor receives a control channel for scheduling a data channel at the reference bandwidth, and receives the data channel at the operating bandwidth.

13. The wireless device of claim 9, wherein the processor receives a control channel for scheduling a data channel at the operating bandwidth, and receives the data channel at the operating bandwidth.
